(19) United States
(12) Patent Application Publication
(10) Pub. No.: US 2026/0225220 A1
(43) Pub. Date: Aug. 6, 2026

(54) ELECTRIC POWER TOOL

(71) Applicant: MAKITA CORPORATION, Anjo-shi (JP)

(72) Inventors: Hiroki KANEKO, Anjo-shi (JP); Takahiro Kawakami, Anjo-shi (JP); Riku Sato, Anjo-shi (JP)

(73) Assignee: MAKITA CORPORATION, Anjo-shi (JP)

(21) Appl. No.: 19/456,202

(22) Filed: Jan. 22, 2026

(30) Foreign Application Priority Data
Jan. 31, 2025 (JP) 2025-014866

(51) Int. Cl. B25F 5/02; B24B 23/02; B25F 5/00

(52) U.S. Cl. CPC B25F 5/02; B24B 23/02; B25F 5/008

(57) ABSTRACT

An electric power tool has a grip center shaft made of metal and an outer resin grip body that is tubular and covers the grip center shaft. The outer resin grip body has a grip main body, an attachment portion, and a notch or a notch entry portion (elastomer portion) made of elastomer. The attachment portion is attached to the grip center shaft to support the grip main body portion in a cantilevered manner. The notch extends in a circumferential direction between the grip main body and the attachment portion. The notch entry portion extends in the circumferential direction to connect the attachment portion and the grip main body. A radial clearance is provided between the grip main body and the grip center shaft to prevent contact therebetween.

### CROSS-REFERENCE TO RELATED APPLICATION

This application claims priority to Japanese patent application serial number 2025-014866, filed on Jan. 31, 2025, the entire contents of which are incorporated herein by reference.

### TECHNICAL FIELD

The present invention generally relates to an electric power tool, and more particularly to a grip structure thereof.

### BACKGROUND ART

Electric power tools such as die grinders or hand grinders are well known. This type of electric power tool has an output shaft and a tip tool aligned extending along a motor shaft axis. An entire power tool extends along the motor shaft axis. For example, a housing that covers the electric motor on its outer side, or a front end portion of a tool main body near the tip tool, may serve as a grip for the user. Typically, the grip at the front end portion of the tool main body near the tip tool is covered with an insulating rubber cover. This prevents the user holding the grip from receiving an electric shock if the tip tool accidentally cuts an electric wire or similar conductor.

To improve workability, it is desirable to provide an electric power tool with a lighting section, such as an LED, at the tip end of the tool main body. For example, wires are routed from a power source, such as a battery, to the lighting section inside the grip at the front end of the tool main body. When wires are routed inside a rubber cover, the wires may undesirably bend during assembly or when the grip is grasped. Covering the grip with an insulating resin cover instead of a rubber cover prevents the wires from bending, thus protecting them.

On the other hand, the resin cover contacts the metal housing on its inner side. Vibrations generated during operation propagate to the metal housing near the tip tool and then to the resin cover, reducing work efficiency.

Furthermore, an electric power tool in which a sub-grip, separate from a main body grip, can be attached to, for example, the electric motor housing near the tip tool is well known. This sub-grip is typically covered with an insulating rubber cover to prevent electric shock. There is also a need for grips covered with an insulating resin cover instead of a rubber cover.

### SUMMARY

Therefore, there is a need to provide an electric power tool that suppresses vibration transmission to the user's grip area and improves work efficiency.

According to one aspect of the present disclosure, the electric power tool has a grip center shaft made of metal and an outer resin grip body that is tubular and covers the grip center shaft. The outer resin grip body has a grip main body, an attachment portion, and a notch or elastomer portion. The attachment portion is attached to the grip center shaft to support the grip main body in a cantilevered manner. The notch extends in a circumferential direction between the grip main body and the attachment portion. The elastomer portion extends in a circumferential direction to connect the attachment portion and the grip main body.

Therefore, the notch or elastomer portion is positioned between the attachment portion and the grip main body. The notch or elastomer portion serves to restrain vibration propagation from the attachment portion, which is attached to the grip center shaft, to the grip main body. This prevents vibration from reaching the grip main body, which a user holds. Consequently, the working efficiency of the electric power tool can be improved.

### BRIEF DESCRIPTION OF DRAWINGS

FIG. 1 is a perspective view of an electric power tool according to a first embodiment of the present disclosure.

FIG. 2 is a cross-sectional view of the electric power tool taken along a vertical plane extending in a front-rear direction, which is viewed from the left.

FIG. 3 is an exploded perspective view of a grip structure of the electric power tool.

FIG. 4 is a left side view of the grip structure of the electric power tool.

FIG. 5 is an exploded side view of the grip structure of the electric power tool, showing an outer resin grip body separated from a grip center shaft.

FIG. 6 is a front view of the electric power tool.

FIG. 7 is an exploded bottom view of the grip structure of the electric power tool, showing a wiring cover portion and wires.

FIG. 8 is a cross-sectional view taken along line VIII-VIII of FIG. 4.

FIG. 9 is a cross-sectional view taken along line IX-IX of FIG. 4.

FIG. 10 is a cross-sectional view taken along line X-X of FIG. 4.

FIG. 11 is a cross-sectional view of the grip center shaft and the outer resin grip body, viewed from the left, corresponding to the section of FIG. 2 but limited to the grip structure.

FIG. 12 is a top view of the outer resin grip body.

FIG. 13 is a rear view of the outer resin grip body.

FIG. 14 is a perspective view of an electric power tool according to a second embodiment of the present disclosure.

FIG. 15 is a left side view of an outer resin grip body of an electric power tool according to a third embodiment of the present disclosure.

FIG. 16 is a top view of an outer resin grip body of an electric power tool according to a fourth embodiment of the present disclosure.

### DETAILED DESCRIPTION

The detailed description set forth below, when considered with the appended drawings, is intended to be a description of exemplary embodiments of the present disclosure and is not intended to be restrictive and/or representative of the only embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the disclosure. It will be apparent to those skilled in the art that the exemplary embodiments of the disclosure may be practiced without these specific details. In some instances, these specific details refer to well-known structures, components, and/or devices that are shown in block diagram form in order to avoid obscuring significant aspects of the exemplary embodiments presented herein.

According to another aspect of the present disclosure, the notch or elastomer portion extends over a total range of 180° or more around the entire periphery. Increasing the peripheral length of the notch or elastomer portion further suppresses vibration transmitted from the attachment portion to the grip main body.

According to another aspect of the present disclosure, only a single notch or elastomer portion is provided. Therefore, the amount of resin used to connect the attachment portion and the grip main body can be reduced. Alternatively, the attachment portion and the grip main body may be connected with an elastomer instead of resin. This configuration effectively suppress vibration transmitted from the attachment portion to the grip main body.

According to another aspect of the present disclosure, a plurality of notches or elastomer portions are provided. Therefore, multiple connecting portions are provided between the notches or elastomer portions to connect the attachment portion to the grip main body. Consequently, vibration transmitted from the attachment portion to the grip main body is suppressed while the structure of the grip main body supported by the attachment portion is strengthened.

According to another aspect of the present disclosure, a wire is arranged along the outer peripheral surface of the grip center shaft and covered by the outer resin grip body. Since the outer resin grip body is more rigid than the elastomer, it prevents the wire from bending during assembly and when the user grasps the grip, which includes the grip main body. Consequently, the wire is effectively protected.

According to another aspect of the present disclosure, a recess that houses the wire is formed in the outer peripheral surface of the grip center shaft. Housing the wire in the recess helps prevent bending of the wire during assembly or use. In addition, the recess prevents the grip center shaft from increasing in radial size, allowing the outer resin grip body, which covers the grip center shaft to remain compact in the radial direction.

According to another aspect of the present disclosure, the notch or elastomer portion extends circumferentially, avoiding the peripheral area of the recess so as not to cover an opening of the recess. This arrangement allows the wire to be protected while suppressing vibration transmitted from the attachment portion to the grip main body through the notch or elastomer portion.

According to another aspect of the present disclosure, a lighting section is provided at the tip portion of the grip center shaft. The wire is connected to the lighting section, allowing power to be supplied to it via the wire. For example, illuminating the area around a tip tool with the lighting section can improve work efficiency.

According to another aspect of the present disclosure, the grip main body has an inner diameter sufficient to prevent contact with the grip center shaft. Consequently, vibration transmitted outward from the grip center shaft to the grip main body can be suppressed

According to another aspect of the present disclosure, the electric power tool includes a tool main body, the grip center shaft, an output shaft, and a detachable portion. The tool main body houses an electric motor, and the grip center shaft is tubular and extends longitudinally from the tool main body. The output shaft is inserted into the grip center shaft and rotated by the electric motor. The detachable portion enables the tip tool to be attached to and detached from the output shaft, which is inserted inside the grip center shaft. This configuration suppresses vibration transmitted from the grip center shaft to the grip main body of the outer resin grip body, which covers the grip center shaft. Consequently, vibration transmitted from the grip, including the grip main body near the tip tool, to the user's hand is reduced, thereby improving work efficiency.

According to another aspect of the present disclosure, the grip main body is tubular. The attachment portion has a rectangular tubular shape extending radially outward from the grip main body. The attachment portion has fastening portions at the four corners and vent windows positioned to avoid the fastening portions and extending through the attachment portion. The grip center shaft includes the tubular portion located on the inner peripheral side of the grip main body, the recess extending axially along the outer surface of the tubular portion to house the wire, and the rectangular tubular portion located on the inner side of the attachment portion. The rectangular tubular portion has fastened portions at the four corners screwed to the fastening portions, and inner vent windows located on the inner side of the vent windows and extending through the rectangular tubular portion. The grip main body has the inner diameter sufficient to prevent contact with the tubular portion. A clearance is provided between the attachment portion and the rectangular tubular portion, sufficient to prevent contact except at the fastened portions 3h and the fastening portions.

Therefore, the attachment portion of the outer resin grip body and the rectangular tubular portion of the grip center shaft are fastened together at the fastening portions and the fastened portion. The clearance is provided around areas other than the fastening portions to suppress vibration propagation. The radial clearance is provided between the grip main body of the outer resin grip body and the tubular portion of the grip center shaft to further suppress vibration transmission. This limits vibration propagation from the grip center shaft to the outer resin grip body to the fastening portions only, effectively reducing vibration reaching the grip main body. Additionally, the grip main body can be made radially compact by incorporating the recess in the tubular portion to accommodate wire.

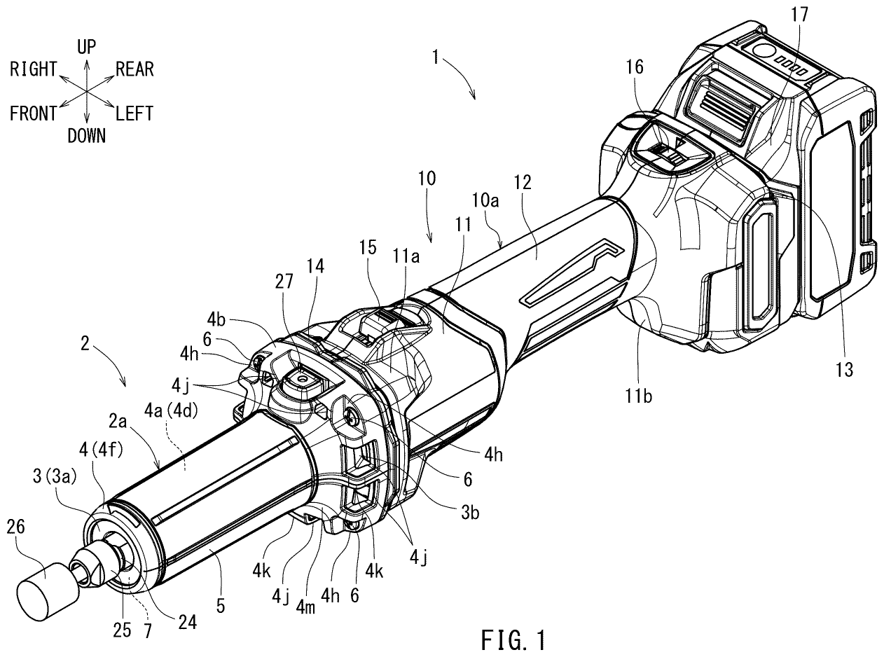

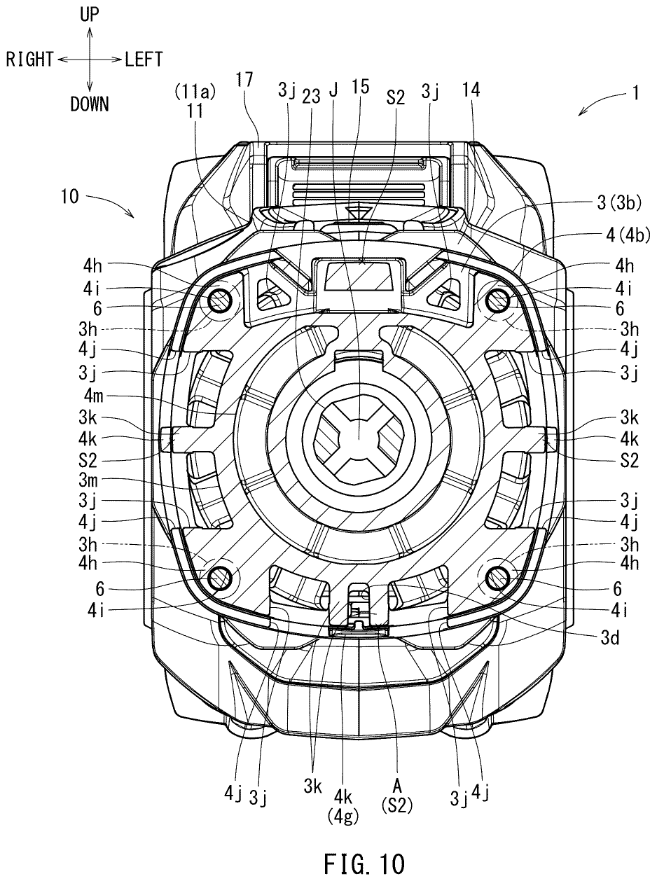

The first embodiment of the present disclosure will now be described with reference to FIGS. 1 to 13. As an example of an electric power tool, a power tool 1, commonly referred to as a die grinder or hand grinder, is illustrated. The electric power tool 1 has a tubular tool main body 10 and an output shaft 24 protruding from the front end of the tool main body 10. A tip tool (tool bit) 26 is attached to the front end of the output shaft 24. In the following description, a side of the tip end from which the output shaft 24 protrudes is referred to as a front side, and a side of the tool main body 10 is referred to as a rear side. A user of the electric power tool 1 is typically positioned at the rear of the electric power tool 1 to grasp grips 2a and 10a. Up-down and left-right directions are defined relative to the user's viewpoint when grasping the electric power tool 1.

As shown in FIG. 1, a front portion of the tool main body 10 includes a grip structure 2. The front portion of the grip structure 2 is formed in a tubular shape extending in the front-rear direction. The rear portion of the grip structure 2 has a rectangular tubular shape, making it wider than the front portion in the up-down and left-right directions. The user grasps the grip 2a, which is the tubular portion of the grip structure 2. The grip structure 2 includes an inner grip center shaft 3 and an outer resin grip body 4. The grip center shaft 3 is made of metal, for example, aluminum. The outer resin grip body 4 is made of an insulating resin that is harder than, for example, rubber. The outer resin grip body 4 is partially covered by an elastomer layer 5. The tool main body 10 located behind the grip structure 2 is covered with a main body housing 11 made of, for example, resin.

As shown in FIG. 1, the front portion of the main body housing 11 includes a front widened portion 11a having a rectangular tubular shape, which has the same shape as the rear portion of the outer resin grip body 4. The main body housing 11 behind the front widened portion 11a is covered with an elastomer layer 12. The portion covered by the elastomer layer 12 forms another grip 10a, which is grasped by the user separately from the grip structure 2. The grip 10a has a tubular shape extending in the front-rear direction and is smaller in both the up-down and left-right directions than the front widened portion 11a. The rear of the main body housing 11 includes a rear widened portion 11b having a rectangular tubular shape, which is larger than the grip 10a in both the front-rear and left-right directions.

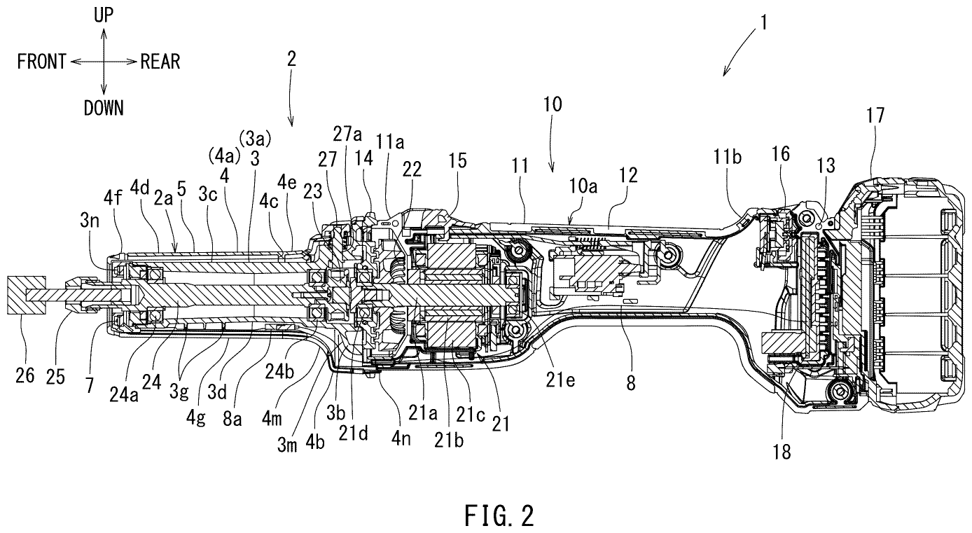

As shown in FIG. 1, a switch lever 15 is disposed on the top surface of the front widened portion 11a. The switch lever 15 is configured to slide in the front-rear direction and can be operated with a finger while the user is grasping the grip 10a. The switch lever 15 is used to switch the driving state of the electric motor 21 (see FIG. 2) between ON and OFF. A selector dial 16 is disposed on the top surface of the rear widened portion 11b. By rotating the selector dial 16 with a finger, the user can change the rotation speed of the electric motor 21, thereby changing the rotation speed of the output shaft 24.

As shown in FIG. 2, a battery attachment portion 13 is located on the rear surface of the rear widened portion 11b. A battery 17 can be removably attached to the battery attachment portion 13. The battery 17 is attached by sliding downward and removed by sliding upward. The battery 17 supplies power to the electric motor 21, the controller 18, and other components. The battery 17 can be repeatedly recharged using a separate charger and can also serve as a power source for other power tools.

As shown in FIG. 2, a controller 18 is housed in the rear widened portion 11b. The controller 18 primarily controls operation of the electric motor 21. The controller 18 is housed in a shallow rectangular box-shaped case that contains a control board. The controller 18 is oriented in the up-down direction along the battery attachment portion 13 and located in front of it. The controller 18 is electrically connected to the battery 17 when mounted in the battery attachment portion 13.

As shown in FIG. 2, the front widened portion 11a houses an electric motor 21, which is a brushless motor. The electric motor 21 is electrically connected to the controller 18 via an unillustrated wire. A motor shaft 21a of the motor 21 extends in the front-rear direction and is supported by front and rear bearings 21d and 21e for rotation about its axis. The front bearing 21d is supported by a plate 14, and the rear bearing 21e is supported by the main body housing 11. A rotor 21b is mounted on the rear portion of the motor shaft 21a and rotates together with it. A stator 21c is disposed radially outward of the rotor 21b and is attached to the inner peripheral surface of the front widened portion 11a. The motor shaft 21a rotates in response to signals transmitted from the controller 18. Driving power is supplied from the battery 17.

As shown in FIG. 2, a fan 22 is mounted on the front end of the motor shaft 21a. The fan 22 is positioned between the front bearing 21d and the rotor 21b and stator 21c. The fan 22 rotates together with the motor shaft 21a. As the fan 22 rotates, cooling air flows through the main body housing 11 from the rear toward the front. This cooling air cools the electric motor 21 and the controller 18. The cooling air from the fan 22 is directed toward the rear surface of plate 14 and discharged through a vent window in the grip structure 2.

As shown in FIG. 2, a rectangular flat plate 14 is positioned in front of the electric motor 21. The plate 14 extends vertically and horizontally and is located between the front widened portion 11a and the grip structure 2. The motor shaft 21a passes through plate 14 and extends into the grip center shaft 3 located ahead. The motor shaft 21a connects to the output shaft 24 via the anti-rotation engaging portion 23 in the rectangular tubular portion 3b of the grip center shaft 3. The output shaft 24 extends along the same axis as the motor shaft 21a and rotates together with the motor shaft 21a. The output shaft 24 is rotatably supported by the grip center shaft 3 via a front bearing 24a and a rear bearing 24b. The front bearing 24a is mounted on the inner periphery at the front end of tubular portion 3a, while the rear bearing 24b is mounted at the junction of tubular portion 3a and rectangular tubular portion 3b.

As shown in FIG. 2, the front end of the output shaft 24 extends forward beyond the front end of the grip structure 2. A detachable portion 25 is provided at the front end of the output shaft 24, allowing a tip tool 26 to be removably attached. The motor shaft 21a, the output shaft 24, and the tip tool 26 are aligned along the front-rear direction. The tip tool 26, when attached to the detachable portion 25, rotates around the output shaft 24.

As shown in FIG. 2, an anti-rotation lever 27 is located on the upper rear surface of the grip structure 2. An anti-rotation member 27a protrudes rearward from the anti-rotation lever 27, with an anti-rotation engaging portion 23 positioned below it. The anti-rotation lever 27 and member 27a are biased upward but can be pressed downward. Pressing the anti-rotation lever 27 moves the anti-rotation member 27a downward so that its tip engages with the anti-rotation engaging portion 23. This locks the output shaft 24, allowing the tip tool 26 to be easily attached to or detached from the detachable portion 25.

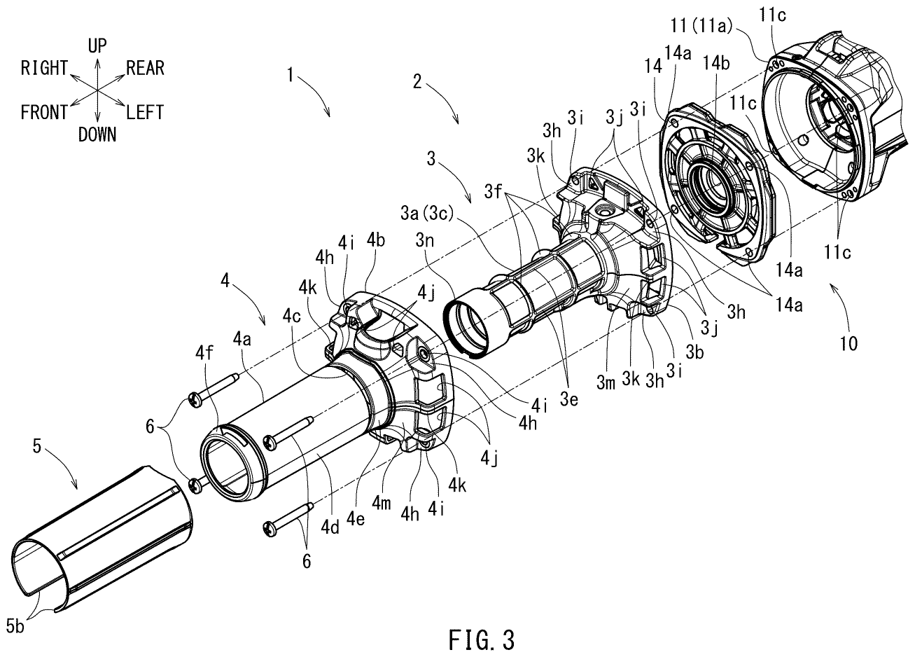

As shown in FIG. 3, the grip center shaft 3 includes a front tubular portion 3a and a rear rectangular tubular portion 3b. The tubular portion 3a has a tubular shape extending in the front-rear direction. The rectangular tubular portion 3b is rectangular and wider than the tubular portion 3a in the up-down and left-right directions. The tubular portion 3a connects to the rectangular tubular portion 3b through a tapered portion 3m in the front-rear direction. A surface of the tapered portion 3m gradually widens from the front to the rear. The surface of the tapered portion 3m includes an arcuate concave surface curved toward the rear. The outer surface of the tubular portion 3a is provided with ribs 3e and 3f extending radially outward. The rib 3e extends in the front-rear direction. The rib 3f extends circumferentially. In the present disclosure, the outer peripheral surface 3c of the grip center shaft 3 includes the outer surfaces of the tubular portion 3a, rectangular tubular portion 3b, tapered portion 3m, ribs 3e and 3f.

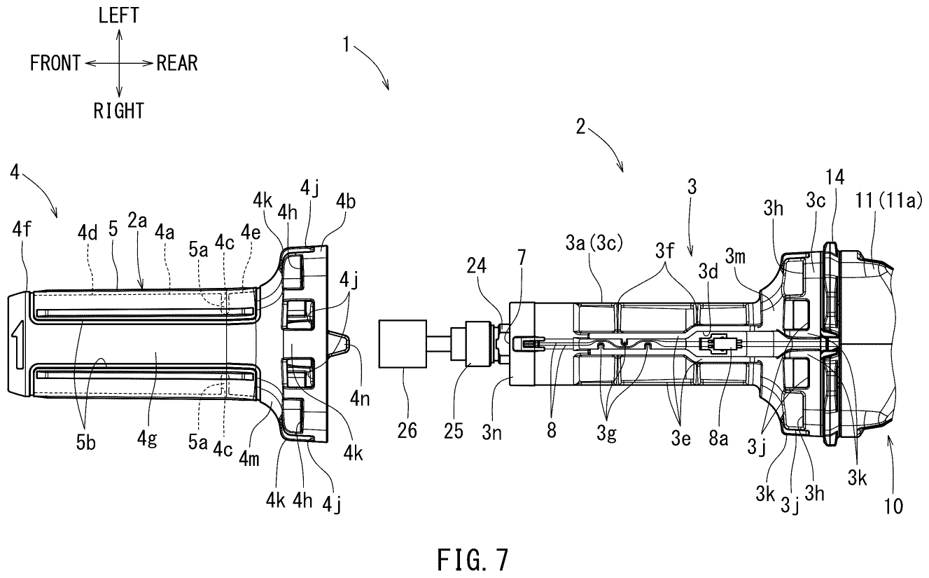

As shown in FIG. 7, a recess 3d is located at the lower portion of the tubular portion 3a. The recess 3d is surrounded by two ribs 3e extending in the front-rear direction. The recess 3d is concave inwardly in the radial direction with respect to the two ribs 3e. Wires 8 extending in the front-rear direction are placed in the recess 3d. The recess 3d is formed to be concave with a depth greater than the outer diameter of the wire 8. The wires 8 extend rearward from the recess 3d and is inserted into the main body housing 11. The recess 3d houses a connector 8a that connects the wires 8. A front portion of recess 3d is provided with a plurality of short ribs 3g that connects to the rib 3e and extend slightly in the circumferential direction. The plurality of short ribs 3g form a labyrinth structure in the recess 3d. The wires 8 arranged in the recess 3d are guided in a meandering path by the short ribs 3g, thereby preventing misalignment relative to the grip center shaft 3.

As shown in FIG. 7, a lighting section 7 is located at the front end of tip portion 3n of tubular portion 3a. The lighting section 7 includes a light-emitting device, such as an LED, that emits light when powered. It illuminates the area around the tip tool 26 by projecting light forward. The lighting section 7 is electrically connected to wires 8, which are inserted into the main body housing 11 as shown in FIG. 2 and connected to the controller 18. The lighting section 7 emits light when, for example, the controller 18 drives the electric motor 21. Power is supplied to the lighting section 7 from the battery 17 through the controller 18 and wires 8.

As shown in FIG. 3, a fastened portion 3h is located at each of the four corners of the rectangular tubular portion 3b. Each fastened portion 3h includes a circular through-hole 3i penetrating in the front-rear direction. The rectangular tubular portion 3b is provided with a plurality of inner vent windows 3j that penetrate the rectangular tubular portion 3b from inside to outside. The inner vent windows 3j are formed in the area between each fastened portion 3h. The inner vent windows 3j extend through the rectangular tubular portion 3b in the front-rear or radial direction. Ribs 3k are provided in the rectangular tubular portion 3b to divide each inner vent window 3j.

As shown in FIG. 3, the outer resin grip body 4 includes a tubular portion 4a at the front

and an attachment portion 4b at the rear. The tubular portion 4a is tubular, extending in the front-rear direction. The tubular portion 4a is larger than the tubular portion 3a of the grip center shaft 3 in diameter and covers the tubular portion 3a from the outside. The attachment portion 4b is a rectangular tubular portion that is wider than tubular portion 4a in the up-down and left-right directions. The attachment portion 4b is larger than the rectangular tubular portion 3b of the grip center shaft 3 and covers the rectangular tubular portion 3b from the outside. The tubular portion 4a connects to the attachment portion 4b via a tapered portion 4m in the front-rear direction. A surface of tapered portion 4m gradually widens from front to rear. The surface of the tapered portion 4m includes an arcuate concave surface curved toward the rear. The tapered portion 4m is larger than the tapered portion 3m of the grip center shaft 3 and covers the rectangular tubular portion 3b from the outside.

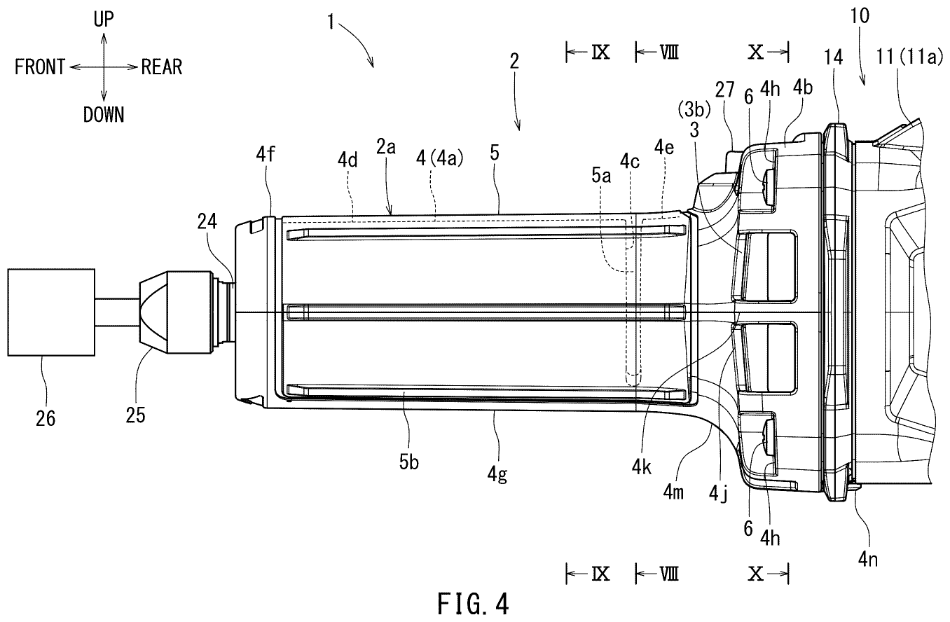

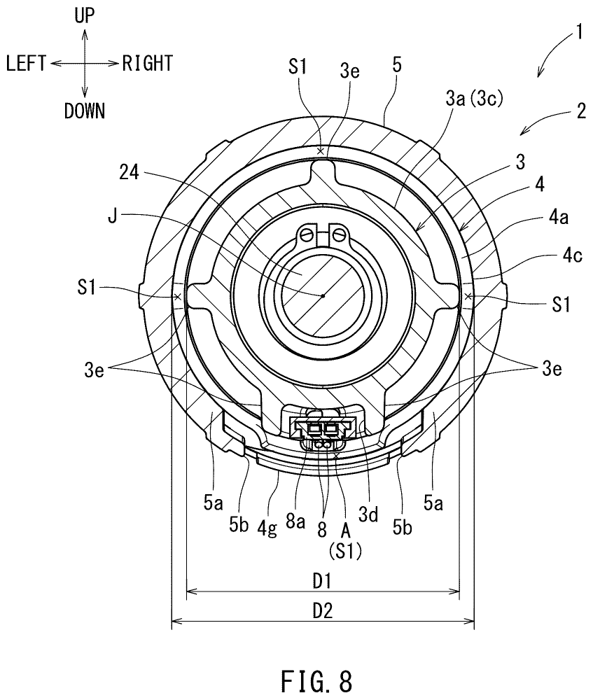

As shown in FIG. 3, a notch 4c extending in the circumferential direction is formed at the rear of the tubular portion 4a. The notch 4c penetrates radially through the tubular portion 4a. The notch 4c extends at least 180° in the circumferential direction of the tubular portion 4a. The notch 4c extending circumferentially by a center angle of at least 180°, and may be 240°, 270°, 300°, or even 330°, for example 270° (see FIGS. 8 and 12). The tubular portion 4a in front of the notch 4c is the grip main body 4d, which is located on the inner side of the grip 2a. A user grasps the grip 2a with the grip main body 4d covered with an elastomer layer 5. The tubular portion 4a behind the notch 4c is a rear notch portion 4e. The grip main body 4d is longer than the notch rear notch portion 4e in the front-rear direction. The grip main body 4d is at least 4 times, and preferably 6, 8, or 10 times longer than the rear notch portion 4e in the front-rear direction, typically at least 6 times longer (see FIG. 4).

As shown in FIG. 4, a tip widened portion 4f is located at the front end of the tubular portion 4a. The tip widened portion 4f extends radially outward from the grip main body 4d and the rear notch portion 4e, both covered with the elastomer layer 5. A radial height difference between the tip widened portion 4f and the grip main body 4d is approximately equal to the thickness of the elastomer layer 5 covering the grip main body 4d.

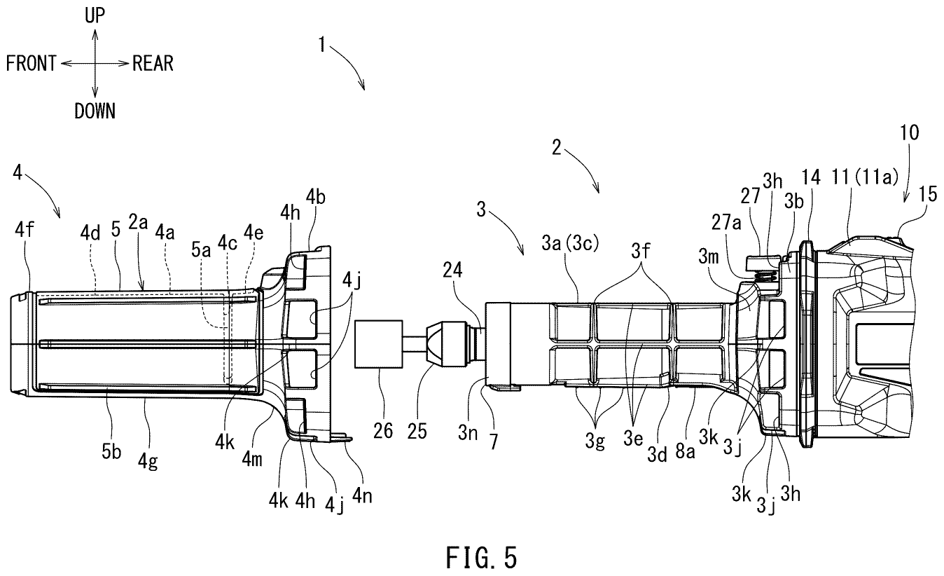

As shown in FIG. 5, a wiring cover portion 4g is located on the lower side of the tubular portion 4a. The wiring cover portion 4g extends in the front-rear direction between the tip widened portion 4f and the attachment portion 4b. The wiring cover portion 4g is not covered by the elastomer layer 5. The wiring cover portion 4g extends radially outward from the grip main body 4d and the rear notch portion 4e by approximately the same thickness as the elastomer layer 5 covering the grip main body 4d and the rear notch portion 4e. The wiring cover portion 4g covers the recess 3d and the wires 8 (FIG. 7) housed within it from the outside.

As shown in FIG. 4, the elastomer layer 5 covers the outer surface of the tubular portion 4a. The elastomer layer 5 is integrally formed with the tubular portion 4a. The elastomer layer 5 covers the grip main body 4d, the notch 4c, and the rear notch portion 4e from the outside. The elastomer layer 5 does not cover the wiring cover portion 4g. Therefore, a peripheral end 5b of the elastomer layer 5 is located at a peripheral end of the wiring cover portion 4g. The elastomer layer 5 includes a notch entry portion (elastomer portion) 5a that enters radially inward into the notch 4c. The elastomer layer 5 and the notch entry portion 5a are seamlessly integrated and made by the same material. The notch entry portion 5a fills the notch 4c without any clearance. Therefore, a peripheral length of the notch entry portion 5a is approximately the same as the peripheral length of the notch 4c. The notch entry portion 5a enters the inner peripheral surface of the tubular portion 4a to the same radial position. The grip main body 4d connects to the rear notch portion 4e through the elastomer of the notch entry portion 5a in the front-rear direction.

As shown in FIG. 3, a fastening portion 4h is located at each of the four corners of the attachment portion 4b. Each fastening portion 4h includes a circular through-hole 4i extending in the front-rear direction. The attachment portion 4b is provided with a plurality of vent windows 4j that penetrate the attachment portion 4b from inside to outside. The vent windows 4j are formed in the area between each fastening portion 4h. The vent windows 4j extend through the attachment portion 4b in the front-rear or radial direction. Ribs 4k are provided in the attachment portion 4b to divide each vent window 4j.

As shown in FIG. 7, a rear protruding portion 4n is located on a lower rear end of the attachment portion 4b. The rear protruding portion 4n is a flat plate extending rearward from the attachment portion 4b. The rear protruding portion 4n covers the notch in the lower portion of the plate 14 through which the wires 8 are inserted, from the outside. The wiring cover portion 4g, the tapered portion 4m, the lower rib 4k, and the rear protruding portion 4n of the outer resin grip body 4 cooperate to cover the wires 8 from the outside such that the wires 8 are not exposed to the outside. Covering the wires 8 with the rigid outer resin grip body 4, rather than the elastomer layer 5, prevents wire flexure.

As shown in FIG. 3, each of the four corners of the plate 14 has a circular through-hole 14a that extends through in the front-rear direction. A circular central through-hole 14b is formed at the center of the plate 14, through which the motor shaft 21a is inserted (see FIG. 2). Four screw holes 11c are formed on the front end surface of the front widened portion 11a of the main body housing 11, with one screw hole located at each corner of the front widened portion 11a.

As shown in FIG. 3, the outer resin grip body 4, the grip center shaft 3, the plate 14, and the main body housing 11 are fastened together by four bolts 6, aligning them in the front-rear direction. First, the outer resin grip body 4 is placed over the grip center shaft 3. Each of the four bolts 6 is inserted through a corresponding through-hole 4i in the outer resin grip body 4 and the through-hole 3i in the grip center shaft 3. Next, each bolt 6 passes through a corresponding through-hole 14a in the plate 14, and is then fastened into a corresponding screw holes 11c in the main body housing 11. In this way, the outer resin grip body 4, the grip center shaft 3, the plate 14, and the main body housing 11 are securely fastened together. The outer resin grip body 4 is supported on the grip center shaft 3 by the fastening portion 4h in a cantilevered manner.

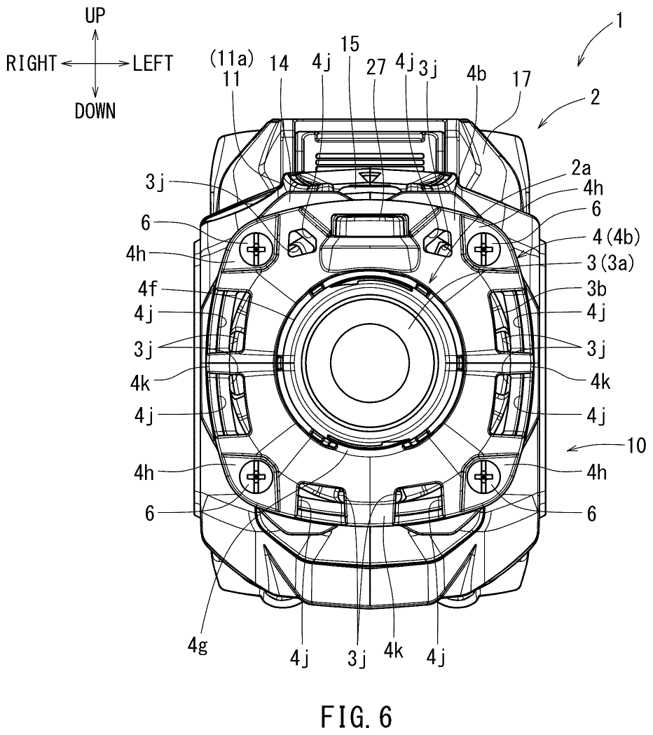

As shown in FIG. 6, the plurality of inner vent windows 3j in the rectangular tubular portion 3b are aligned with the plurality of vent windows 4j in the attachment portion 4b in the front-rear or radial direction. Therefore, each inner vent window 3j and each vent window 4j cooperate to form an exhaust opening. Cooling air generated inside the main body housing 11 by the fan 22 (see FIG. 1) is discharged outward through these inner vent windows 3j and vent windows 4j.

FIG. 8 shows a cross-section of the grip structure 2 at the same position as the notch 4c in the front-rear direction. As shown in FIG. 8, the wiring cover portion 4g of the outer resin grip body 4 covers a peripheral area A of the recess 3d of the grip center shaft 3 in the peripheral (left-right) direction. In other words, the wiring cover portion 4g covers the recess 3d, preventing it from being exposed not only in the front-rear direction but also in the circumferential direction. Meanwhile, the notch 4c and the notch entry portion 5a of the elastomer layer 5 are positioned to avoid the peripheral area A of the recess 3d. The inner peripheral surface of the wiring cover portion 4g is located radially outward of the outer peripheral end of the rib 3e of the grip center shaft 3. Therefore, the wiring cover portion 4g does not contact the grip center shaft 3.

As shown in FIG. 8, the outer peripheral surface 3c of the grip center shaft 3 projects outward the most at the rib 3e. The inner peripheral surface of the outer resin grip body 4 is approximately at the same radial position as the inner peripheral surface of the elastomer of the notch entry portion 5a, which enters radially inward into the notch 4c. The maximum outer diameter D1 of the grip center shaft 3 is smaller than the inner diameter D2 of the inner peripheral surface of the outer resin grip body 4 (or of the notch entry portion 5a). Therefore, a radial clearance S1 exists between the grip center shaft 3 and the outer resin grip body 4 or the elastomer layer 5. This clearance S1 is generally symmetrical (both in the up-down and left-right directions) with respect to the axis center J, and extends over the entire peripheral direction. In other words, the grip center shaft 3 does not contact the outer resin grip body 4 or the elastomer layer 5 in the cross section shown in FIG. 8.

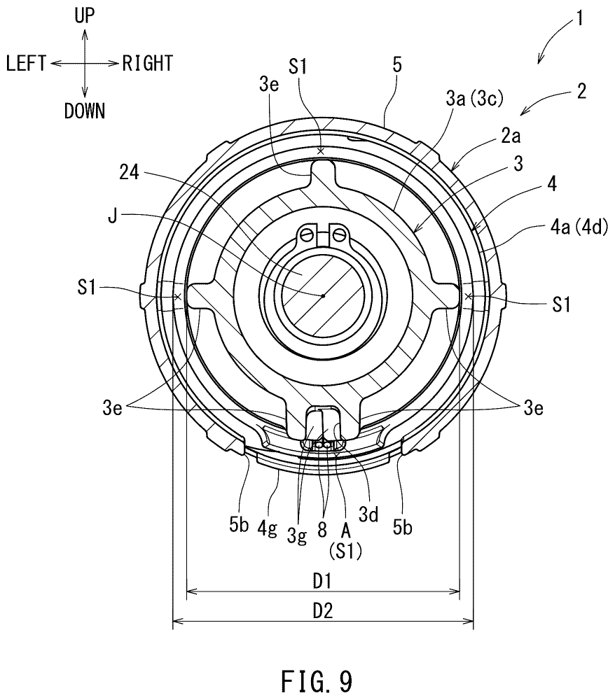

FIG. 9 shows a cross-section of the grip structure 2 located in front of the notch 4c (see FIG. 4). As shown in FIG. 9, the outer resin grip body 4 is positioned between the grip center shaft 3 and the elastomer layer 5 in the radial direction at all peripheral position. In this cross section, as in FIG. 8, a radial clearance S1 exists between the grip center shaft 3 and the outer resin grip body 4 around the entire peripheral direction. In other words, the grip center shaft 3 does not contact the outer resin grip body 4 in the cross section shown in FIG. 9.

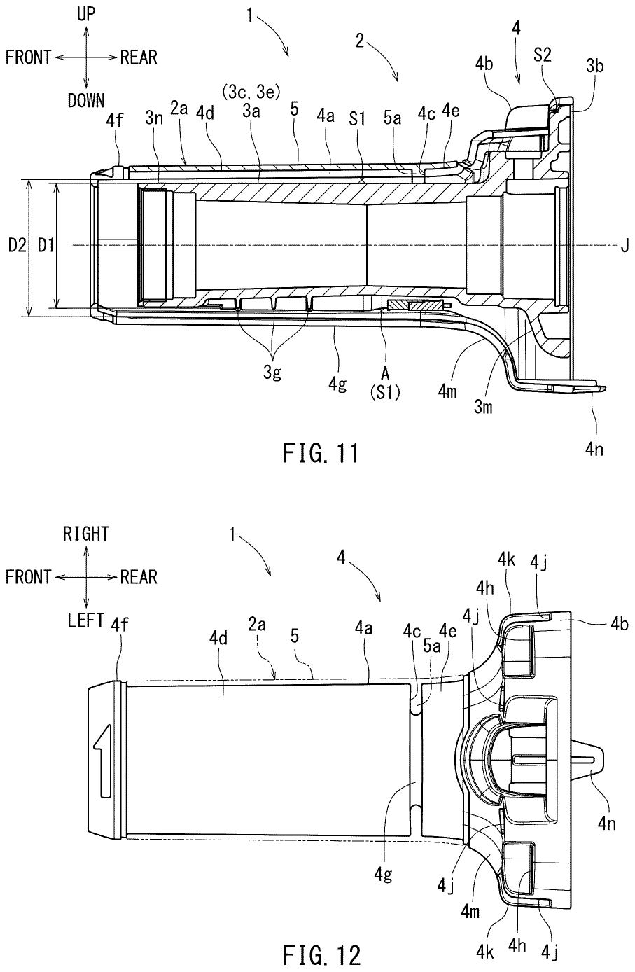

As shown in FIG. 11, the radial clearance S1 between the grip center shaft 3 and the outer resin grip body 4 extends along the entire length of the tubular portion 3a and the grip main body 4d in the front-rear direction. The upper clearance S1 maintains approximately the same radial width (in the up-down direction) throughout the tubular portion 3a and the grip main body 4d in the front-rear direction. Similarly, the lower clearance S1 maintains approximately the same radial width along the tubular portion 3a and the wiring cover portion 4g, except at the short rib 3g. In the cross section shown in FIG. 11, an additional clearance S2 exists between the rectangular tubular portion 3b and the attachment portion 4b, sufficient to prevent contact caused by vibration. In other words, in the cross section shown in FIG. 11, the tubular portion 3a does not contact the grip main body 4d, and the rectangular tubular portion 3b does not contact the attachment portion 4b.

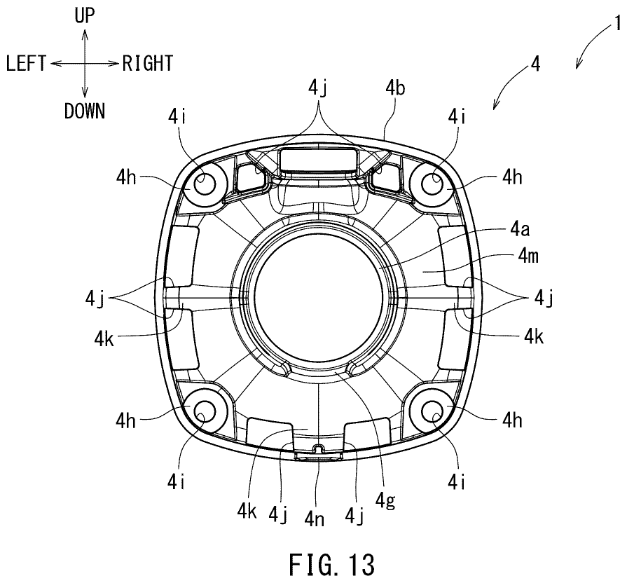

As shown in FIG. 1, the rectangular tubular portion 3b contacts the attachment portion 4b at the fastened portion 3h and the fastening portion 4h, which are fastened together. The fastening portion 4h has a tubular boss shape, as shown in FIG. 13. A clearance S2 is provided between the rectangular tubular portion 3b and the attachment portion 4b in areas other than the fastened portion 3h and the fastening portion 4h. This clearance S2 is sufficient to prevent the rectangular tubular portion 3b from contacting the attachment portion 4b due to vibration. For example, each rib 3k and each rib 4k are aligned radially and maintain the clearance S2 between them. Therefore, the region where vibration transmitted from the output shaft 24 (see FIG. 2) to the grip center shaft 3 can propagate to the outer resin grip body 4 is limited to the vicinity of the fastening portion 4h of the attachment portion 4b.

As shown in FIG. 3, the fastening portion 4h is positioned behind the notch 4c in the tubular portion 4a. Therefore, even if vibration is transmitted to the fastening portion 4h, its propagation to the grip main body 4d, located further forward of the notch 4c, can be effectively suppressed.

As described above, the electric power tool 1 includes the grip center shaft 3 made of metal and the outer resin grip body 4 that is tubular and covers the grip center shaft 3, as shown in FIG. 4. The outer resin grip body 4 comprises the grip main body 4d, the attachment portion 4b, and the notch 4c or elastomer notch entry portion (elastomer portion) 5a. The attachment portion 4b is attached to the grip center shaft 3 to support the grip main body 4d in a cantilevered manner. The notch 4c extends circumferentially between the grip main body 4d and the attachment portion 4b. The notch entry portion 5a extends circumferentially to connect the attachment portion 4b and the grip main body 4d.

Therefore, the notch 4c or the notch entry portion 5a is positioned between the attachment portion 4b and the grip main body 4d. The notch 4c or the notch entry portion 5a serves to restrain vibration propagation from the attachment portion 4b, which is attached to the grip center shaft 3, to the grip main body 4d. This prevents vibration from reaching the grip 2a, which a user holds. Consequently, the work efficiency of the electric power tool 1 can be improved.

As shown in FIG. 8, the notch 4c or the notch entry portion 5a extends over a total range of 180° or more around the entire periphery. Increasing the peripheral length of the notch 4c or the notch entry portion 5a further suppresses vibration transmitted from the attachment portion 4b to the grip main body 4d.

As shown in FIG. 4, only one notch 4c or one notch entry portion 5a is provided. Therefore, the amount of resin used to connect the attachment portion 4b and the grip main body 4d can be reduced. Alternatively, the attachment portion 4b and the grip main body 4d may be connected with an elastomer instead of resin. This configuration effectively suppresses vibration transmitted from the attachment portion 4b to the grip main body 4d.

As shown in FIGS. 7 to 9 and 11, the wires 8 are arranged along the outer peripheral surface 3c of the grip center shaft 3 and are covered by the outer resin grip body 4. Since the outer resin grip body 4 is more rigid than the elastomer, it prevents the wires 8 from bending during assembly and when the user grasps the grip 2a, which includes the grip main body 4d. Consequently, the wires 8 are effectively protected.

As shown in FIGS. 7 to 9 and 11, the recess 3d that houses the wires 8 is formed in the outer peripheral surface 3c of the grip center shaft 3. Housing the wires 8 in the recess 3d helps prevent bending of the wires 8 during assembly or use. In addition, the recess 3d prevents the grip center shaft 3 from increasing in radial size, allowing the outer resin grip body 4, which covers the grip center shaft 3, to remain compact in the radial direction.

As shown in FIG. 8, the notch 4c or the notch entry portion 5a extends circumferentially, avoiding the peripheral area A of the recess 3d so as not to cover an opening of the recess 3d. This arrangement allows the wires 8 to be easily arranged while suppressing vibration transmitted from the attachment portion 4b to the grip main body 4d through the notch 4c or the notch entry portion 5a.

As shown in FIGS. 7 and 11, the lighting section 7 is provided at the tip portion 3n of the grip center shaft 3. The wires 8 are connected to the lighting section 7, allowing power to be supplied to it via the wires 8. For example, illuminating the area around the tip tool 26 with the lighting section 7 can improve work efficiency.

As shown in FIGS. 8, 9 and 11, the grip main body 4d has an inner diameter D2 sufficient to prevent contact with the grip center shaft 3. Consequently, vibration transmitted outward from the grip center shaft 3 to the grip main body 4d can be suppressed.

As shown in FIG. 2, the electric power tool 1 includes the tool main body 10, the grip center shaft 3, the output shaft 24, and the detachable portion 25. The tool main body 10 houses the electric motor 21, and the grip center shaft 3 is tubular and extends longitudinally from the tool main body 10. The output shaft 24 is inserted into the grip center shaft 3 and rotated by the electric motor 21. The detachable portion 25 enables the tip tool 26 to be attached to and detached from the output shaft 24, which is inserted inside the grip center shaft 3. This configuration suppresses vibration transmitted from the grip center shaft 3 to the grip main body 4d of the outer resin grip body 4, which covers the grip center shaft 3. Consequently, vibration transmitted from the grip 2a, including the grip main body 4d near the tip tool 26, to the user's hand is reduced, thereby improving work efficiency.

As shown in FIGS. 3 and 8 to 10, the grip main body 4d is tubular. The attachment portion 4b has a rectangular tubular shape extending radially outward from the grip main body 4d. The attachment portion 4b has fastening portions 4h at the four corners and vent windows 4j positioned to avoid the fastening portions 4h and extending through the attachment portion 4b. The grip center shaft 3 includes the tubular portion 3a located on the inner peripheral side of the grip main body 4d, the recess 3d extending axially along the outer surface 3c of the tubular portion 3a to house the wires 8, and the rectangular tubular portion 3b located on the inner side of the attachment portion 4b. The rectangular tubular portion 3b has fastened portions 3h at the four corners screwed to the fastening portions 4h, and inner vent windows 3j located on the inner side of the vent windows 4j and extending through the rectangular tubular portion 3b. The grip main body 4d has the inner diameter D2 sufficient to prevent contact with the tubular portion 3a. A clearance S2 is provided between the attachment portion 4b and the rectangular tubular portion 3b, sufficient to prevent contact except at the fastened portions 3h and the fastening portions 4h.

Accordingly, the attachment portion 4b of the outer resin grip body 4 and the rectangular tubular portion 3b of the grip center shaft 3 are fastened together at the fastening portions 4h and the fastened portion 3h. The clearance S2 is provided around areas other than the fastening portions to suppress vibration propagation. The radial clearance S1 is provided between the grip main body 4d of the outer resin grip body 4 and the tubular portion 3a of the grip center shaft 3 to further suppress vibration transmission. This limits vibration propagation from the grip center shaft 3 to the outer resin grip body 4 to the fastening portions only, effectively reducing vibration reaching the grip main body 4d. Additionally, the grip main body 4d can be made radially compact by incorporating the recess 3d in the tubular portion 3a to accommodate wires 8.

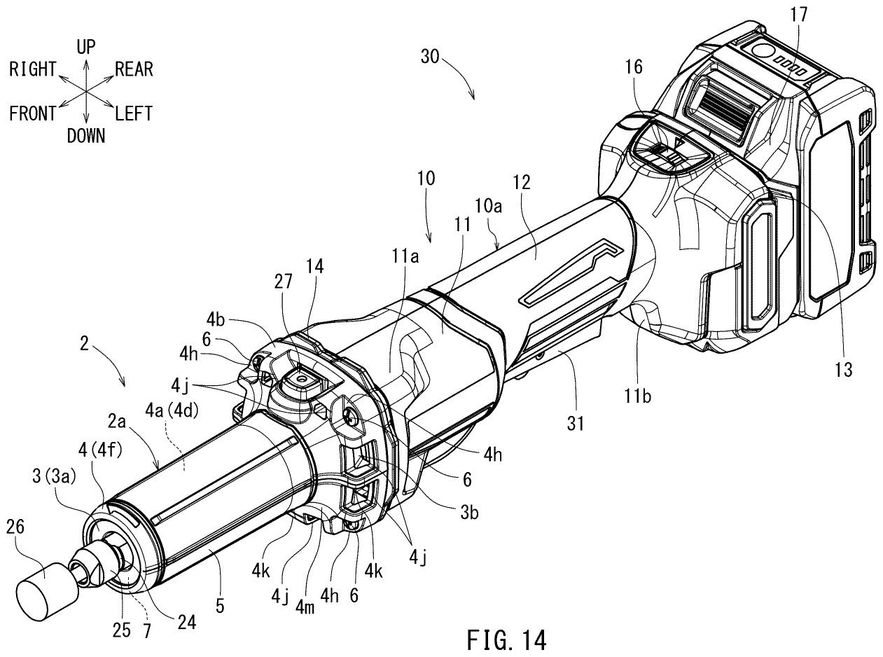

A second embodiment of the present disclosure is described with reference to FIG. 14. In this embodiment, the electric power tool 30 includes a switch lever 31 instead of the switch lever 15 of the electric power tool 1 of the first embodiment shown in FIG. 1. The switch lever 31 is positioned below the grip 10a. In this electric power tool 30, the same effect as the first embodiment is achieved by arranging the grip structure 2 on the front side of the tool main body 10. For example, vibration propagation to the grip 2a of the grip structure 2 is suppressed, improving work efficiency.

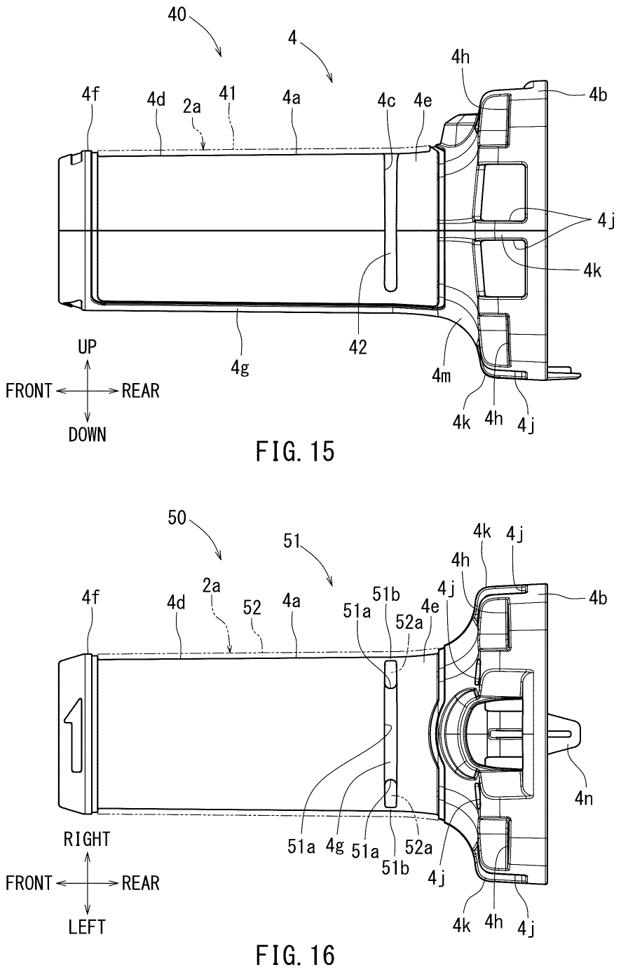

A third embodiment of the present disclosure is described with reference to FIG. 15. In this embodiment, the electric power tool 40 includes an elastomer layer 41 and an elastomer portion 42 instead of the elastomer layer 5 of the first example shown in FIG. 4. The elastomer layer 41 and the elastomer portion 42 are provided separately and are individually connected to the outer resin grip body 4. The elastomer portion 42 is filled into the notch 4c without clearance, connecting the grip main body 4d and a rear notch portion 4e. The elastomer layer 41 covers the grip main body 4d, the elastomer portion 42, and the rear notch portion 4e from radially outside. In the electric power tool 40, the elastomer portion 42 suppresses vibration propagation to the grip main body 4d on the front end side thereof, thereby achieving the same effect as the first embodiment.

A fourth embodiment of the present disclosure is described with reference to FIG. 16. In this embodiment, the electric power tool 50 includes an outer resin grip body 51 instead of the outer resin grip body 4 of the first embodiment shown in FIG. 1. The outer resin grip body 51 includes a plurality of notches, for example, three notches 51a, instead of a single notch 4c. Hereinafter, only portions different from the first embodiment will be described in detail. The plurality of notches 51a have the same width in the front-rear direction and are positioned circumferentially at the same front-rear location. The plurality of notches 51a are circumferentially partitioned by the wiring cover portion 4g and connecting portions 51b that connect the grip main body 4d and the rear notch portion 4e. The plurality of notches 51a extend over a total range of 180° or more, e.g., 270° or more, around the entire periphery. Each notch 51a is filled with an elastomer that is integral with the elastomer layer 52 covering the grip main body 4d and the rear notch portion 4e, forming a notch entry portion (elastomer portion) 52a without clearance.

In the electric power tool 50 described above, the same effect as the first embodiment is achieved by the notches 51a formed in the outer resin grip body 51. In addition, as shown in FIG. 16, the plurality of notches 51a or the elastomer portions are provided. Therefore, connecting portions 51b are provided between the notches 51a or the elastomer portions to connect the attachment portion 4b to the grip main body 4d. Consequently, vibration transmitted from the attachment portion 4b to the grip main body 4d is suppressed while the structure of the grip main body 4d supported by the attachment portion 4b is strengthened.

The electric power tools 1, 30, 40, and 50 described in the embodiments can be modified as necessary. In the embodiments, the electric power tool such as a die grinder or hand grinder is illustrated. However, the present disclosure can be applied to various electric power tools that generate vibration and are grasped by the user, such as disk grinders, multi-tools. Furthermore, in the embodiments, the motor shaft 21a is aligned (coaxial) with the output shaft 24. However, the present disclosure can also be applied to an electric power tool in which the motor shaft 21a and the output shaft 24 are not aligned but extend in the same direction and are parallel to each other. The present disclosure may further be applied to a side grip disclosed in the prior art.

In the embodiments, the grip 2a has a tubular shape. However, the shape of the grip 2a is not limited to the tubular shape, but may, for example, be prismatic or have a non-uniform thickness. In the embodiments, the grip main body 4d and the rear notch portion 4e are connected by the wiring cover portion 4g, and the elastomer portions 5a and 42 are not provided over the entire periphery (i.e., their peripheral length is less than 360°). Alternatively, the grip main body may be separated from the rear notch portion, and these portions may be connected by the elastomer portions provided over the entire periphery. In the embodiments, the notch 4c and the elastomeric part 5a are arranged to avoid the peripheral area A of the recess 3d of the grip center shaft 3. Alternatively, the notch 4c and elastomer portion 5a may be arranged to extend into the peripheral area A of the recess 3d.

In the embodiments, the notches 4c, 51a and the elastomer portion are provided at the same front-rear locations around the peripheral direction. Alternatively, the notches and elastomer portions may be extended in a spiral configuration. Furthermore, multiple notches and elastomer portions may be provided at different front-rear locations. In the embodiments, the notches 4c, 51a and elastomer portions are arranged asymmetrically in the up-down direction, with the wiring cover portions 4g positioned at the bottom. Alternatively, the notches and elastomer portions may be arranged symmetrically in the up-down direction, with the wiring cover portion, which is a non-notched connection portion, positioned on the upper side. The number of notches and elastomer portions is not limited to that in the embodiments, and may be varied as needed.

In the embodiments, the clearance S2 is provided between the rectangular tubular portion 3b of the grip center shaft 3 and the attachment portion 4b of the outer resin grip body 4. Alternatively, no clearance may be provided between the rib 3k of the rectangular tubular portion 3b and the rib 4k of the attachment portion 4b, while still avoiding contact caused by vibration. Even without such clearance, the notch 4c and elastomer section 5a can still suppress propagation of vibration to the grip 2a located forward.

We claim:

1. An electric power tool comprising:
a grip center shaft made of metal; and
an outer resin grip body that is tubular and covers the grip center shaft,
wherein the outer resin grip body further comprises:
a grip main body;
an attachment portion configured to be attached to the grip center shaft to support the grip main body in a cantilevered manner; and
at least one of (i) a notch extending in a circumferential direction between the grip main body and the attachment portion, and (ii) an elastomer portion extending in the circumferential direction to connect the attachment portion and the grip main body.

2. The electric power tool according to claim 1, wherein the notch or the elastomer portion extends circumferentially by at least 180°.

3. The electric power tool according to claim 1, wherein the outer resin grip body includes a single notch or a single elastomer portion.

4. The electric power tool according to claim 1, wherein the outer resin grip body includes a plurality of notches or a plurality of elastomer portions.

5. The electric power tool according to claim 1, further comprising at least one wire disposed along an outer peripheral surface of the grip center shaft,
wherein the at least one wire is covered by the outer resin grip body.

6. The electric power tool according to claim 5, further comprising a recess configured to house the at least one wire,
wherein the recess is formed in the outer peripheral surface of the grip center shaft.

7. The electric power tool according to claim 6, wherein the notch or the elastomer portion extends circumferentially while avoiding a peripheral region of the recess.

8. The electric power tool according to claim 5, further comprising a lighting section located at a distal end portion of the grip center shaft,
wherein the at least one wire is connected to the lighting section.

9. The electric power tool according to claim 1, wherein the grip main body has an inner diameter sufficient to prevent contact with the grip center shaft.

10. The electric power tool according to claim 1, further comprising:
a tool main body that houses an electric motor;
an output shaft inserted into the grip center shaft and rotated by the electric motor; and
a detachable portion configured to allow a tip tool to be attached to and detached from the output shaft,
wherein the grip center shaft is tubular and extends longitudinally from the tool main body.

11. The electric power tool according to claim 1, wherein
the grip main body is tubular,
the attachment portion has a polygonal tubular shape extending radially outward from the grip main body, the attachment portion further comprising:
a fastening portion provided at each of a plurality of corners of the attachment portion; and
at least one vent window positioned to avoid the fastening portions and extending through the attachment portion,
wherein the grip center shaft further comprises:
a tubular portion located on an inner periphery of the grip main body;
a recess extending axially along an outer surface of the tubular portion to house at least one wire; and
a polygonal tubular portion located on an inner side of the attachment portion,
wherein the polygonal tubular portion further comprises:
a fastened portion provided at the each of the plurality of corners and configured to be secured to the fastening portions; and
at least one inner vent window located on an inner side of the at least one vent window and extending through the polygonal tubular portion,
the grip main body has an inner diameter sufficient to prevent contact with the tubular portion, and
a clearance is provided between the attachment portion and the polygonal tubular portion, the clearance being sufficient to prevent contact except at the fastened portions and the fastening portions.

12. The electric power tool according to claim 6, further comprising a plurality of ribs formed on the outer peripheral surface of the grip center shaft, each rib extending radially outward and longitudinally along the grip center shaft,
wherein the recess is disposed between two adjacent ribs of the plurality of ribs.

13. The electric power tool according to claim 12, further comprising a plurality of short rib formed on the outer peripheral surface of the grip center shaft, wherein
each of the plurality of short rib extends circumferentially along the grip center shaft and connects to at least one of the plurality of ribs.

14. The electric power tool according to claim 13, further comprising a connector positioned within the recess, wherein
the at least one wire is connected to the connector and arranged in a meandering path guided by the plurality of ribs and the plurality of short ribs.

15. The electric power tool according to claim 1, wherein the outer resin grip body comprises the notch, an elastomer layer covering at least a part of an outer surface of the grip main body, and an elastomer notch entry portion that enters radially inward into the notch,
wherein the elastomer layer and the elastomer notch entry portion are integrally formed or separately formed.

16. The electric power tool according to claim 10, wherein a motor shaft of the electric motor is coaxial with or parallel to the output shaft.

17. The electric power tool according to claim 11, further comprising:
a first tapered portion via which the tubular portion of the grip center shaft is connected to the polygonal tubular portion;
a second tapered portion via which the tubular grip main body is connected to the attachment portion, wherein the second tapered portion being radially larger than the first tapered portion so as to cover the first tapered portion;
a plate disposed rearward of the grip center shaft; and
a bolt extending through the fastening portion of the outer resin grip body, the fastened portion of the grip center shaft, and the plate so as to fasten the outer resin grip body, the grip center shaft, and the plate to a tool main body of the electric power body,
wherein the second tapered portion is radially larger than the first tapered portion to cover the first tapered portion.

18. The electric power tool according to claim 6, wherein,
the outer resin grip body further comprises a wiring cover portion extending in a front-rear direction to cover the recess of the grip center shaft from a radially outer side, and
the wiring cover portion connects the attachment portion to the grip main body such that the notch is interrupted in a circumferential direction by the wiring cover portion.

19. The electric power tool according to claim 18, further comprising an elastomer layer covering the grip main body, wherein
the elastomer layer does not cover the wiring cover portion.

20. The electric power tool according to claim 1, wherein the electric power tool is selected from the group consisting of a die grinder, a hand grinder, a disk grinder, and a multi-tool.
